(19) United States
(12) Patent Application Publication
(10) Pub. No.: US 2023/0284820 A1
(43) Pub. Date: Sep. 14, 2023

(54) SINGLE-SERVING COFFEE POD AND SINGLE-SERVING BEVERAGE BREWER SYSTEM

(71) Applicant: TBDx Inc., Alamo, CA (US)

(72) Inventors: Qiliang Xu, Alamo, CA (US); Rui Zhou, Sunnyvale, CA (US)

(21) Appl. No.: 17/890,812

(22) Filed: Aug. 18, 2022

Related U.S. Application Data
(60) Provisional application No. 63/319,723, filed on Mar. 14, 2022.

(51) Int. Cl. A47J 31/52; B65D 85/804; A47J 31/40

(52) U.S. Cl. CPC A47J 31/521; A47J 31/407; B65D 85/8046; B65D 85/8058

(57) ABSTRACT

A single-serving coffee pod includes: a hollow capsule having an opening at a first end thereof and at least one smaller opening in a second end thereof opposite the first end; a filter disposed within the capsule; a plurality of whole coffee beans located within the capsule; and a removable covering disposed over the opening of the capsule.

### CROSS REFERENCE TO RELATED APPLICATION

The present application claims the benefit of U.S. Provisional Patent Application No. 63/319,723, entitled “Automatic Whole-bean Capsule Coffee Machine,” filed Mar. 14, 2022.

### BACKGROUND

Existing capsule-based coffee machines extract coffee from coffee grounds that are pre-packaged in a capsule (or “pod”) with only one or a few fixed brewing settings/options. These brewing options cannot be adjusted or optimized for the particular coffee grounds used. Therefore, their ability to extract the flavors of many different coffee varieties to the full extent is limited. This limitation, combined with the lack of freshness in pre-ground coffee, has contributed to a large difference in quality between a black coffee served in a boutique café and one prepared by a conventional capsule-based coffee machine. For example, in a boutique café, a barista often perfects the cup of coffee with their understanding of the coffee beans and a unique choice of extraction parameters, including grind size, water temperature, coffee-to-water ratio, pouring methods, etc. Therefore, there is no easy, affordable and convenient solution on the market that enables the complete customization of brewing recipes and produces café-quality black coffee at home. It is now recognized that a need exists for a capsule-based brewer capable of providing customized brewing recipes to produce high quality brewed beverages, such as coffee, in any environment where a high-quality beverage is desired.

### SUMMARY

The present disclosure is directed to a single-serving coffee pod, including: a hollow capsule having an opening at a first end thereof and at least one smaller opening in a second end thereof opposite the first end; a filter disposed within the capsule; a plurality of whole coffee beans located within the capsule; and a removable covering disposed over the opening of the capsule.

The present disclosure is also directed to a single-serving coffee pod, including: a hollow capsule configured to hold whole coffee beans therein and to receive coffee grounds made from the whole coffee beans; and an identification tag disposed on the capsule, the identification tag configured to be scanned by a reader, wherein the identification tag is configured to provide or trigger access to information upon scanning of the identification tag by the reader, the information corresponding to the whole coffee beans held in the capsule, corresponding to a recipe for brewing coffee from the whole coffee beans in the capsule, or both.

The present disclosure is also directed to a single-serving beverage brewing system including: a brewer including a reader; and a single-serving pod including: a hollow capsule configured to hold a brewing agent therein; and an identification tag disposed on the capsule, wherein the brewer further includes a processor communicatively coupled to the reader, wherein in response to the reader reading the identification tag, the processor is configured to access or retrieve information regarding: the brewing agent, a recipe for brewing a beverage from the brewing agent, or both.

### BRIEF DESCRIPTION OF THE DRAWINGS

FIGS. 1A and 1B are side and front views of a brewer, in accordance with an embodiment of the present disclosure.

FIG. 2 is a schematic diagram of a system for brewing beverages, in accordance with an embodiment of the present disclosure.

FIGS. 3A-3C depict an example user interface for use with a brewer, in accordance with an embodiment of the present disclosure.

FIG. 4 is a cutaway view of a whole-bean single-serving coffee pod, in accordance with an embodiment of the present disclosure.

FIGS. 5A-5C depict an example capsule dock and linear positioning stage of a brewer, in accordance with an embodiment of the present disclosure.

FIG. 6 is a process flow diagram of a method for grinding coffee beans using a brewer, in accordance with an embodiment of the present disclosure.

FIGS. 7A and 7B are front and perspective cutaway views of a grinder of a brewer, in accordance with an embodiment of the present disclosure.

FIG. 8 is a front schematic cutaway view of a solid state pouring system for use in a brewer, in accordance with an embodiment of the present disclosure.

FIG. 9 is a schematic view of an arrangement of electrodes around a pouring nozzle, in accordance with an embodiment of the present disclosure.

FIGS. 10A-10D are bottom, side, perspective, and exploded views of an example single-serving coffee pod, in accordance with an embodiment of the present disclosure.

FIGS. 11A-11C are exploded, bottom, and top views of another example single-serving coffee pod, in accordance with an embodiment of the present disclosure.

FIG. 12 is an exploded view of another example single-serving coffee pod, in accordance with an embodiment of the present disclosure.

FIG. 13 is a side view of another example single-serving coffee pod, in accordance with an embodiment of the present disclosure.

### DESCRIPTION OF EMBODIMENTS

This application describes exemplary single-serving coffee pods and exemplary single-serving beverage brewing systems.

Single-serving beverage brewers (also known as “capsule” or “pod″-based brewers) are becoming commonplace in individual homes to provide single-serving cups of coffee, tea, and other hot beverages. However, existing capsule-based brewers lack the ability to tailor the brewing method to the particular type of coffee, tea, etc. being brewed. Typically, the only adjustment to the brewing method is a selection of the volume of beverage output from the brewer. It is now recognized that a need exists for a capsule-based brewer capable of providing customized brewing recipes to produce high quality brewed beverages, such as coffee, in a home environment.

This application discloses a new category of capsule-based coffee machines and their enabling technologies. The disclosed product allows several brewing conditions to be set to any combinations, giving a roaster or barista complete control of how the coffee is prepared even without their presence. The brewing conditions may include: grind size, brewing temperature, coffee-to-water ratio, brewing duration, pouring patter, pouring rate, agitation, and/or “blooming.” For customers, the process is done by the touch of a button, retaining the convenience of a conventional pod-based machine. The machine can recognize the type of beans in the pod and search for the best-matched recipes. The recipe can be created by the roasters who produce the coffee, well-trained barista(s) who have studied and tested the particular type of coffee beans, or coffee drinkers themselves. As such, the disclosed capsule-based brewer functions as an at-home barista. The disclosed brewer enables high-end coffee makers to provide premium coffee drinks (not just beans) to customers for enjoyment of the drinks in their peak form, without leaving home.

The present disclosure provides single-serving coffee pods and a single-serving beverage brewing system that can be used to brew a high quality single serving of coffee or other hot beverage using a specifically tailored pouring technique applied to a brewing agent in the pod. The single-serving coffee pods may hold whole coffee beans, thus providing whole beans to the brewer for grinding immediately prior to the brewing process. Each single-serving coffee pods may include an identification tag that can be read by the brewer and used to control the grinding / brewing process. For example, the identification tag may provide information regarding a type of brewing agent that is held in the pod and/or a recipe for grinding / brewing the brewing agent held in the pod to produce an ideal single-serving beverage.

### Brewer Overview

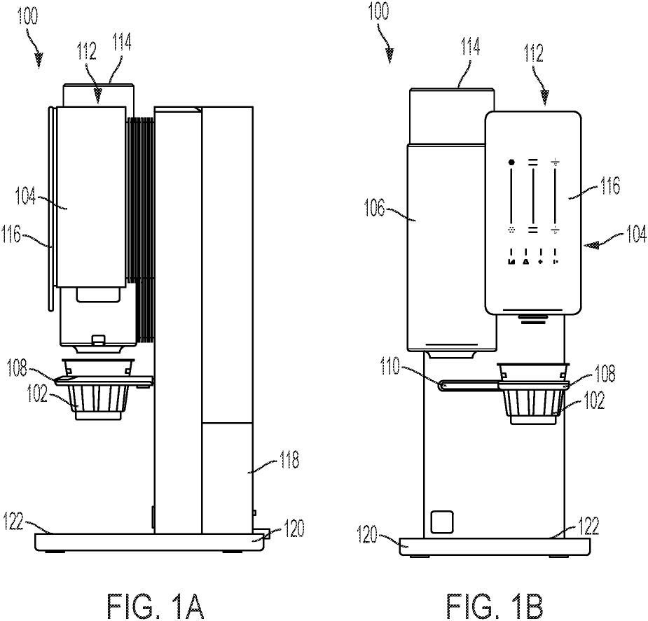

Turning now to the drawings, FIGS. 1A and 1B depict an example brewer 100 in accordance with an embodiment of the present disclosure. The brewer 100 is a capsule-based brewer configured to brew a single serving of coffee, tea, or some other beverage at a time via interaction with a single-serving pod 102. As described in greater detail below, the pod 102 acts as both a container from which a brewing agent (e.g., coffee beans, tea materials, etc.) are provided to the brewer 100 and as a dripper through which hot water output from the brewer is received to contact and extract flavor from the brewing agent in the pod 102. The term “tea” may refer both to teas made from traditional tea leaves as well as other blends of herbs, tisanes, etc. The term “tea materials” may refer to tea leaves, herbs, spices, flowers, dried fruits, or any other materials from which a tea or tisane may be brewed.

In some embodiments, the pod 102 may hold whole coffee beans, as opposed to coffee grounds. Providing whole coffee beans in the pod 102 improves the freshness of the coffee being brewed, since the coffee beans are not ground until immediately before brewing the cup of coffee. Similarly, the pod 102 may hold larger pieces of other brewing agents (e.g., whole tea materials) as opposed to pre-ground brewing agents. The pod 102 may include extraction features in the form of indentations or grooves formed in an outer or bottom wall of the pod 102. The pod 102 also includes an identification tag (e.g., an RFID tag, 2D barcode, etc.), which stores information about the brewing agents and brewing methods. In addition, the pod 102 may include a lid or other removable covering that can be pulled off when it is time to brew a beverage from the pod 102.

The brewer 100 may include, among other things, a water dispenser 104, a grinder 106, a holder (e.g., “capsule dock”) 108, a linear positioning stage 110, and an electronic reader 112. As discussed in detail below, the water dispenser 104 may be a solid state controllable water dispenser able to output water therefrom according to pouring patterns that may be either automatically retrieved for the particular pod 102 or user selected. The water dispenser 104 may include a nozzle configured to dispense a stream of water downward and one or more electrodes configured bend the water stream based on their charge to create the desired pouring pattern.

The grinder 106 may include a burr grinder or any other desired type of grinder suitable for grinding coffee beans, tea materials, and so forth. The grinder 106 may be an adjustable grinder capable of adjusting the grind size of the material output from the grinder 106. The grinder 106 may automatically reset and adjust to a desired grind size in response to receiving a command from a controller in the brewer 100.

The capsule dock 108 may be configured to hold the pod 102. The capsule dock 108 may be configured to hold an empty pod 102 beneath the grinder 106 to receive coffee grounds or tea of a desired size into the pod 102 prior to brewing a beverage. Similarly, the capsule dock 108 may be configured to hold the pod 102 of coffee grounds or tea below the nozzle of the water dispenser 104 to receive the stream of water into the pod 102. A relative position of the capsule dock 108 with respect to the rest of the brewer 100 may be adjusted via the linear positioning stage 110. The linear positioning stage 110 may move the capsule dock 108 between a first location beneath the grinder 106 and a second location beneath the water dispenser 104.

The brewer 100 may be equipped with an electronic reader 112 (e.g., an RFID reader, barcode scanner, etc.) to interrogate the identification tag on the pod 102. As illustrated, the reader 112 of the brewer 100 may be located proximate an opening 114 of the grinder 106 through which whole beans are input into the grinder 106 prior to beginning the grinding / brewing process. That way, the brewer 100 may automatically read the identification tag on each pod 102 prior to beginning the grinding / brewing process. It should be noted, however, that the reader 112 may be located at any other position on the brewer 100. For example, in another embodiment, the reader 112 may be located beneath the grinder 106, for example, near the capsule dock 108. As such, the interrogation may occur as soon as a pod 102 is loaded on the capsule dock 108. With the reader 112 in either of these locations, the users may not need to scan the pod 102 directly.

The brewer 100 may include a user interface 116 through which a user may view information regarding the brewing agent / brewing process associated with the pod 102 and/or input information regarding the brewing process. The user interface 116 may include a display. In an example, as shown in FIG. 1B, the user interface 116 may include a light emitting diode (LED) panel. In other embodiments, the user interface 116 may include a touchscreen display through which information may be selected or input via the user interacting with the touchscreen. Additionally or alternatively, the user may make selections using buttons, dials, etc. on the brewer 100 and/or by pressing the capsule dock 108 at a certain location. In some embodiments, the brewer 100 may not include a user interface. The brewer 100 may instead be communicatively coupled to a user’s personal device (e.g., cell phone) to receive inputs and/or output information regarding the brewing process to the user.

The brewer 100 may include a combination of the water dispenser 104, grinder 106, capsule dock 108, linear positioning stage 110, reader 112, opening 114, and user interface 116 located within, or coupled to, a main housing 118 of the brewer 100. The main housing 118 may be supported on a base 120, as shown. In some embodiments, the base 120 may include a cup holder 122 on which a cup is to be placed to ultimately receive the brewed beverage output through the pod 102 (acting as a dripper) under the water dispenser 104.

The brewer 100 may operate as follows. Although the following description discusses the use of the brewer 100 to brew a cup of coffee from the pod 102, it should be understood that similar steps may be performed in brewing a cup of tea, hot chocolate, cider, or any other hot beverage prepared using a brewing agent.

First, a user removes the pod 102 from its packaging. The pod 102 may contain whole coffee beans, a built-in filter, an identification tag, and certain extraction features of a coffee dripper. The user may remove the lid or other covering from a top of the pod 102 and then empty the coffee beans from the pod 102 through the opening 114 into the grinder 106. The user may then place the empty pod 102 on the capsule dock 108. The empty pod 102 will serve as the filter and dripper once the brewing process begins.

During this process, the reader 112 of the brewer 100 may read the identification tag on the pod 102. The reader 112 detects the type of coffee from the identification tag on the pod 102 and retrieves the best recipe for the coffee beans that were packaged in the pod 102. The brewing recipe may include brewing water temperature, water volume, flow rate, grind size, pouring pattern, brewing duration, coffee-to-water ratio, etc. The brewer 100 may be turned on or “woken up” upon the reader 112 detecting the presence of the identification tag on the pod 102 and/or reading the identification tag.

The brewer 100 may detect the proper loading of the pod 102 onto the capsule dock 108 via a force sensor incorporated in the capsule dock 108. In some embodiments, a user may press down on a portion of the capsule dock 108 to initiate the grinding / brewing process. Upon detecting the proper loading of the pod 102 and/or the user pressing down on the capsule dock 108, the linear positioning stage 110 automatically moves the pod 102 to be underneath the grinder 106 to receive coffee grounds output from the grinder 106.

The grinder 106 automatically adjusts its coarseness / grind size based on the recipe or user preferences. The grinder 106 may automatically recalibrate and set to zero to maintain the accuracy of grind size between subsequent grinding / brewing operations. The coffee grounds fall into the pod 102 held by the capsule dock 108. The integrated force sensor of the capsule dock 108 may measure the exact amount of coffee to be extracted.

Upon completion of grinding, the linear positioning stage 110 then automatically moves the capsule dock 108 with the pod 102, which now contains coffee grounds, to be underneath the water dispenser 104. The water dispenser 104 automatically adjusts the water temperature, flow rate, pouring pattern, and coffee-to-water ratio, based on the detected recipe and/or user preferences. The water dispenser 104 dispenses a water stream from a nozzle of the brewer 100 into the pod 102 holding the coffee grounds. The force sensor on the capsule dock 108, combined with a water flow sensor, monitors the real-time coffee-to-water ratio inside the pod 102 to gain additional control over the brewing process as well as to prevent overflow. The water dispensed into the pod 102 extracts flavor and color from the coffee grounds and is filtered through the pod 102. Coffee exits one or more openings in the bottom of the pod 102 and falls into a cup below.

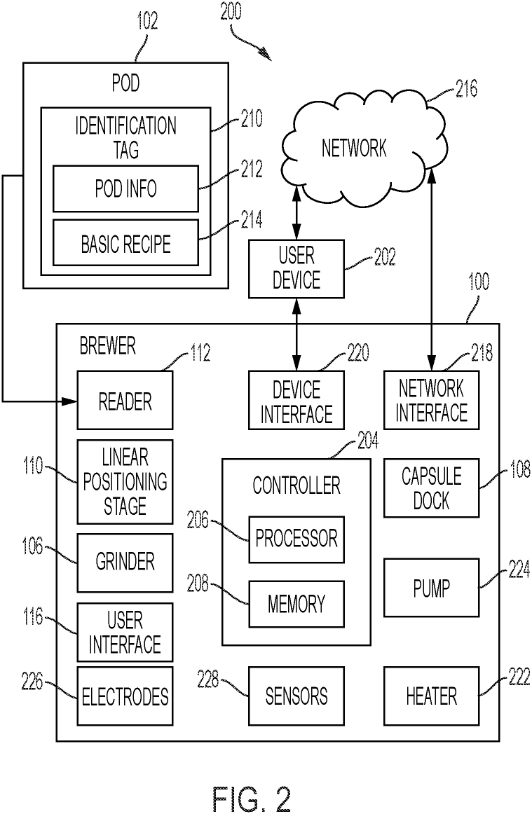

FIG. 2 depicts a system 200 for brewing beverages including a brewer 100 as described above. The system 200 of FIG. 2 illustrates a number of electrical components and communication interfaces that may interact within the brewer 100 and between the brewer 100, the pod 102, and/or a separate user device 202 to control the grinding / brewing process.

The system 200 may be a single-serving beverage brewing system including the brewer 100 and a single-serving pod 102. The brewer 100 comprises the reader 112. The pod 102 may include a hollow capsule configured to hold a brewing agent therein, and an identification tag 210 disposed on the capsule. The brewer 100 may further include a controller 204 comprising one or more processors 206 and memory 208. The memory 208 may store instructions that when executed by the one or more processors 206 determine a brewing recipe for the pod 102, control a grinding / brewing process, and/or cause the controller 204 to perform one or more methods disclosed herein. For example, in response to the reader 112 reading the identification tag 210, the processor(s) 206 may access or retrieve information regarding: the brewing agent, a recipe for brewing a beverage from the brewing agent, or both. As such, the controller 204 may be configured to determine a brewing recipe for the pod 102 and control the brewing process according to the brewing recipe.

The brewing recipe may be determined at least in part based on information retrieved by the electronic reader 112. The reader 112 may scan and/or interrogate the identification tag 210 located on the pod 102 when the pod 102 is brought near a certain location of the brewer 100. The identification tag 210 may include information stored thereon (e.g., in a chip, barcode, etc.). The information stored on the identification tag 210 may include pod information 212 regarding the contents of the pod 102 (e.g., information about coffee beans located in the pod 102). The pod information 212 may include one or more of the following: type of coffee bean, name of the roaster, type of roaster, roast date, and flavor notes. The information stored on the identification tag 210 may also include basic recipe information 214 regarding one or more appropriate (or preferred) recipes for brewing a beverage from the contents of the pod 102. The recipe information 214 may include one or more of the following parameters for brewing a beverage: grind size, water temperature, water to coffee ratio, flow rate, and pouring pattern.

In some embodiments, the identification tag 210 on the pod 102 may not be capable of containing all information associated with the pod and/or the brewing recipe. In such instances, the identification tag 210 may include data including an address or link to information stored in an external network 216. This additional information may include any of the above referenced types of pod information 212, recipe information 214, and/or rich media content including pictures, videos, recommendations, etc. The brewer 100 may include a network interface 218 for retrieving the additional information from the external network 216 based on the link read from the identification tag 210. In some embodiments, the identification tag 210 may simply be a bar code or quick response (QR) code that includes a stock keeping unit (SKU) or link used to access information regarding the pod and/or brewing recipe stored in an external network 216.

The brewer 100 may also include pod information and/or recipe information stored in the memory 208 of the controller 204. In some embodiments, the brewer 100 may access pod and/or recipe information from the memory 208 based on a link or SKU read from the identification tag 210. The brewer 100 may include a number of different pre-set brewing recipes stored in the memory 208, with each SKU being linked to one or more of the pre-set brewing recipes. Upon detecting the identification tag 210, the processor 206 may check the network interface 218 to determine whether the brewer 100 is connected to an external network 216. If the brewer 100 is not connected to the external network 216, the processor 206 may select one or more of the pre-set brewing recipes from memory 208 based on the information read from the identification tag 210. If the brewer 100 is connected to the external network 216, the processor 206 may retrieve one or more brewing recipes from the external network 216 via the network interface 218 based on the information read from the identification tag 210. The recipes and other information stored in both the external network 216 and the on-board memory 208 may be updated periodically, such as when a manufacturer, partner, barista, or user uploads new recipes to the external network 216 for a particular pod.

The system 200 may enable a user to make selections of or updates to the brewing recipe(s) that are determined based on information read from the identification tag 210 on a pod 102. In some embodiments, the brewer 100 may include an on-board user interface 116 having one or more input/output devices for making a selection or an update. For example, the user interface 116 may include a display, a touchscreen, one or more buttons or dials, a keyboard, and/or any other input/output devices that allow a user selection or input to be made to the brewer 100. The user interface 116 may enable a user to make selections of a brewing recipe and/or update one of the presented brewing recipes. Once a selection is made, the user interface 116 may communicate the selection to the controller 204 for implementation.

In some embodiments, the brewer 100 may include a device interface 220 configured to communicatively couple the controller 204 to a user device 202 (e.g., a cell phone) via WIFI, Bluetooth, or any other wired or wireless connection. The device interface 220 may communicate information from the reader 112 to the user device 202, and the user device 202 may be equipped with an application configured to receive the information from the reader 112 and present one or more brewing recipes to a user. The user device 202 may enable a user to make selections of a brewing recipe and/or update one of the presented brewing recipes. Once a selection is made, the device interface 220 may communicate the selection from the user device 202 to the controller 204 for implementation.

The system 200 may enable a user to design an entirely new brewing recipe for a particular SKU from scratch. The user interface 116 and/or an application on the user device 202 may present the user with multiple brewing recipe parameters that may be added, selected, adjusted, and/or removed to create a new brewing recipe. The controller 204 may access the new brewing recipe and control various components of the brewer 100 to execute the grinding / brewing operations of the recipe. The user created recipe may be stored directly in the memory 208 of the brewer 100. The user created recipe may be uploaded and stored in the external network 216 via the network interface 218 and/or the user device 202.

Determining the brewing recipe may include accessing the information stored on the identification tag 210 via the reader 112, and retrieving the brewing recipe directly from information stored on the identification tag 210 or from the external network 216. Determining the brewing recipe may include accessing the information stored on the identification tag 210 via the reader 112, presenting one or more brewing recipes to a user via the user interface 116 and/or a user device 202, obtaining user input(s) regarding the one or more brewing recipes presented, and outputting a brewing recipe selected and/or updated by the user. Determining the brewing recipe may include enabling a user to create a new brewing recipe via the user interface 116 and/or a user device 202.

Upon determining the brewing recipe, the controller 204 may control the brewer 100 to brew a beverage according to the determined brewing recipe. Controlling the brewing process may include controlling: the capsule dock 108, the linear positioning stage 110, the grinder 106, and/or the water dispenser (e.g., 104 of FIGS. 1). Controlling the capsule dock 108 may include providing haptic feedback to a user through the capsule dock 108. Controlling the linear positioning stage 110 may include moving the capsule dock 108 from a first position beneath the grinder to a second position beneath the water dispenser, and/or imparting vibrations to the capsule dock 108 if agitation is required for the brewing recipe. Controlling the grinder 106 may include controlling a grind size for the coffee or other materials placed in the grinder 106.

Controlling the water dispenser (e.g., 104 of FIGS. 1) may include controlling one or more of: a water heater 222, a pump 224, and one or more electrodes 226 proximate a nozzle of the water dispenser. Controlling the heater 222 may include heating the water via the heater 222 to a desired brewing temperature. Controlling the pump 224 may include operating the pump to output water from the nozzle at a desired flow rate. Controlling the one or more electrodes 226 may include controlling one or more electrical circuits to adjust a magnitude of voltage applied to each electrode surrounding the stream of water output from the nozzle.

In addition to the components discussed above, the brewer 100 may further include one or more sensors 228 configured to provide real time or near-real time feedback regarding the grinding / brewing process being controlled by the controller 204. The controller 204 may receive feedback from the sensor(s) 228 and adjust the grinding / brewing operations of the brewer 100 in response to sensor feedback. The sensor(s) 228 may include, for example, a force sensor on the capsule dock 108, temperature and flowrate sensors in the water dispenser, and so forth.

### User Interface

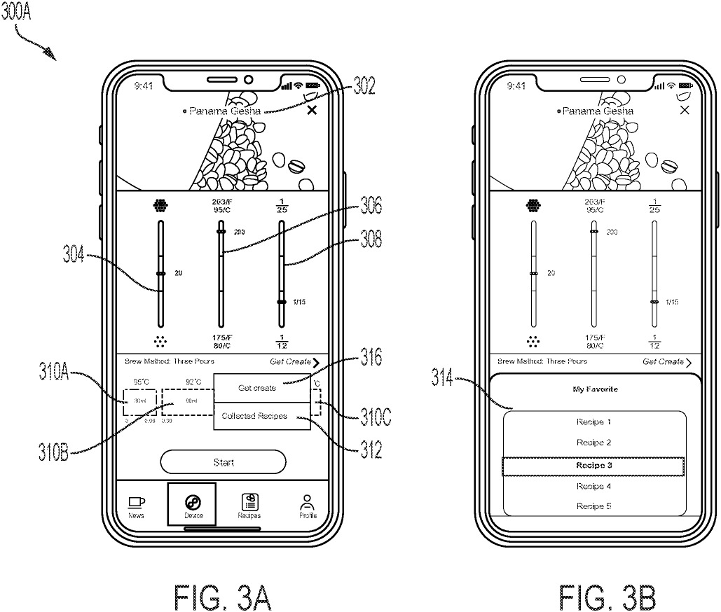

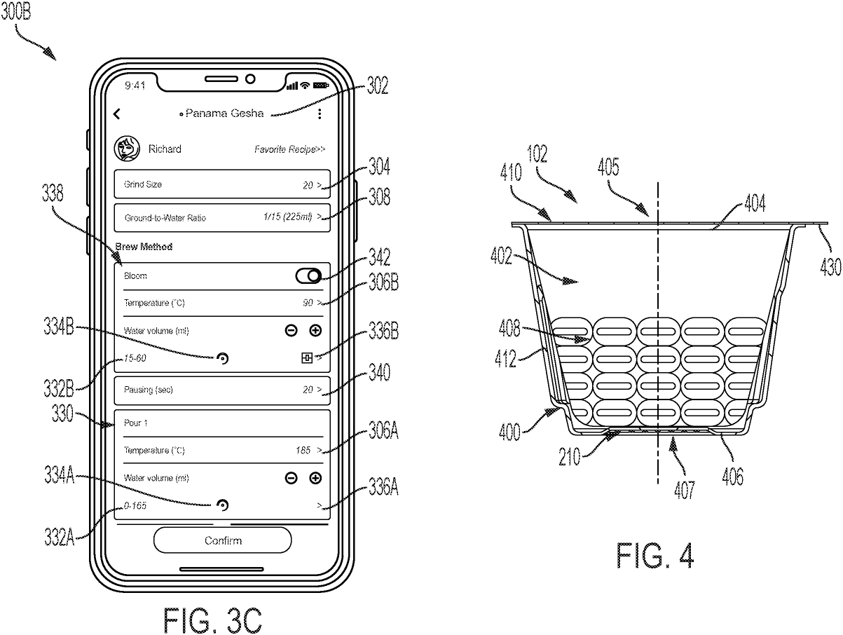

FIGS. 3A-3C depict an example user interface for use with the disclosed brewer. Although shown as an interface of an application on a user device (e.g., cell phone), the user interface may be similarly displayed on a user interface (e.g., 116 of FIG. 2) of the brewer. The interface may enable a user to 1) create a new brewing recipe from scratch, or 2) select and/or adjust an existing brewing recipe retrieved from on-board memory or external storage.

A first page 300A of the user interface includes pod information 302, for example, in the form of a name of the coffee beans in the pod (“Panama Gesha”) as read from an identification tag on the pod. The first page 300A may also include a “default” recipe for the pod, as determined based on the recipe information associated with the pod. The “default” recipe may be a brewing recipe that is designed by the manufacturer of the pod, the most popular or highest rated recipe available from a network database for the pod, or a preferred recipe previously selected for this pod by the user. The “default” recipe may show a number of primary parameters of the brewing recipe including, for example, grind size 304, water temperature 306, and coffee-to-water ratio 308. In other embodiments, different combinations of brewing parameters may be considered primary parameters. The first page 300A may be set up to allow a user to view and/or make changes to the primary parameters of the “default” recipe. For example, in FIG. 3A the grind size 304, water temperature 306, and coffee-to-water ratio 308 are each illustrated via slide bars, which may be adjusted by the user to create a new recipe.

The “default” recipe may include a particular number of pours 310, with each pour 310 having its own set of primary parameters. For example, FIG. 3A illustrates a first page 300A showing the primary parameters for a first pour 310A of three pours 310A-C of the brewing recipe. A user may view or make changes to the primary parameters for any of the other pours 310B or 310C by selecting the pours toward the bottom of the screen.

A user may start from the “default” recipe, as shown, or select another collected recipe 312, for example, by clicking a button. The collected recipes button 312 may provide a list of previously collected recipes (“Favorites”) 314 to choose from, as shown in FIG. 3B. These collected recipes may be ones that a user had previously created and entered into their favorites, popular recipes for the pod retrieved from an online database, or a combination thereof. The user may simply select one of the collected recipes in order to choose the brewing recipe. In other instances, if the user is interested in changing parameters to tailor the taste of the coffee to their preferences, the user may adjust the primary parameters from the selected recipe to design a new brewing recipe. The new brewing recipe may then be saved to the user’s collected recipes.

If the user wants complete freedom in designing the brewing recipe, the user may select a button 316 on the first screen for creating a new recipe for the pod. This allows the user to adjust not only the primary parameters of the brewing process, but also secondary parameters. FIG. 3C illustrates a second page 300B showing the more detailed list of parameters that may be adjusted by a user. The second page 300B of the user interface includes the same pod information 302 as the first page, and the same primary parameters (e.g., grind size 304, water temperature 306, and coffee-to-water ratio 308) and their values as on the first page.

In addition, the second page 300B of the user interface includes other secondary parameters that may be selected or adjusted for a plurality of pours 330. The number of pours 330 that may be selected for the brewing method may be up to 5 pours, up to 10 pours, or more. For each pour 330 (e.g., “Pour 1”), the secondary parameters may include, for example, a volume 332A, a pouring pattern 334A, and agitation 336A. In addition, a user may select for the brewing method to include a “bloom” pour 338 (e.g., prior to the first pour 330) with secondary parameters including a volume 332B, a pouring pattern 334B, agitation 336B, and a bloom duration 340. In other embodiments, different combinations of brewing parameters may be considered secondary parameters for the different pours.

A bloom pour 338 may be added by toggling a switch 342 on the user interface, which allows the user to tailor the bloom pour 338 as desired. A bloom pour 338 allows for carbon dioxide to release from the coffee grounds before beginning potentially larger pours of the brewing process. Coffee grounds often include a certain amount of CO₂ trapped inside, and once in contact with water the CO₂ tries to escape, expanding the serving of coffee grounds. Baristas will often give the coffee a time to “bloom,” that is giving the CO₂ time to escape, so that the CO₂ does not prevent water from touching the coffee grounds during subsequent pours. The second page 300B of the user interface allows a user to add a bloom pour 338, choose the volume 332B, pouring pattern 334B, and agitation 336B of the bloom pour 338, and to specify a length of time (bloom duration 340) for the coffee grounds to “bloom” before the next pour 330.

Secondary parameters of both the bloom pour 338 and subsequent pours 330 can be adjusted by the user. The volume 332A/B may be the volume in milliliters of water that is dispensed during the pour. The pouring pattern 334A/B may be selected from a predetermined group of dynamic patterns in which water might be dispensed into the pod held under the water dispenser. Such dynamic patterns may include a spiral pattern (either an expanding spiral or an inward moving spiral), a circle, a point (e.g., “center pour”), a straight line, a wave shape, or a zig-zag shape. The dynamic patterns may also indicate whether the pour is happening more slowly (e.g., in a laminar flow regime) or quickly (e.g., in a turbulent flow regime). The different pouring patterns may bring out different aspects of the flavor profile from the coffee grounds. A user may select or adjust the pouring pattern for any number of the pours 330, including the bloom pour 338. The agitation 336A/B may be an option to include mechanical agitation of the coffee grounds and water in the pod during the pour. For example, if mechanical agitation is selected (e.g., as shown at 336B for the bloom pour 338), the linear positioning stage may vibrate the capsule dock holding the pod back and forth at a high frequency to agitate the coffee grounds in the pod during the pour. If mechanical agitation is not selected (e.g., as shown at 336A for the first pour 330), the linear positioning stage maintains the capsule dock in a stationary position throughout the pour.

The user interface of FIGS. 3A-3C may provide three levels of interaction that a user may have with setting the brewing method for brewing coffee or another beverage from a pod. If a user wishes to simply select a brew method from a list of favorites associated with the pod, they can do so using, for example, a dropdown list as in FIG. 3B. If a user wishes to adjust primary parameters of a recommended brew method, they can do so using, for example, the first page 300A in FIG. 3A. If the user wishes to adjust all possible parameters including primary and secondary parameters to create a new brew method, they can do so using, for example, the second page 300B in FIG. 3C. The user interface in FIGS. 3A-3C provides only one example of the types of parameters that may be chosen by a user and a layout for doing so. Other versions of the user interface may enable a user to create, select, or adjust different combinations of parameters of a brewing method to be performed via the brewer.

### Single-Serving Pod Overview

FIG. 4 is a detailed cutaway view of the pod 102 that may be used with the brewer of FIGS. 1-2. In FIG. 4, the pod 102 is a single-serving coffee pod. In other embodiments, the pod 102 may be a single-serving pod for other types of beverages that may be brewed using the disclosed brewer. The pod 102 is configured to serve as a holder for a brewing agent, a dripper, and a filter. To that end, the single-serving pod 102 may include a hollow capsule 400 and a filter 402 disposed within the capsule 400. The capsule 400 has an opening 404 at a first end 405 thereof and at least one smaller opening 406 in a second end 407 thereof opposite the first end 405. As illustrated, a plurality of whole coffee beans 408 may be located within the capsule 400. The coffee beans 408 may be located in the filter 402 so that they can be easily poured out of the pod 102 through the opening 404 at the top of the capsule 400. The pod 102 may include a removable covering 410 disposed over the opening 404. The pod 102 may also include the identification tag 210 located on an outside of the capsule 400. In the illustrated embodiment, the identification tag 210 is located on a bottom of the capsule 400. However, the identification tag 210 may be placed at another location of the capsule 400 in other embodiments. The capsule 400 may include multiple structural extraction features 412 (e.g., in the form of protrusions and/or indentations) that help to strengthen the capsule 400 and prevent clogging of the pod 102 during its use as a filter/dripper.

The identification tag 210 may store information (or an address linking to such information) about the coffee beans 408 stored in the pod 102, and/or about a method or recipe for brewing the coffee beans 408 stored in the pod 102. Each pod 102 may have a particular SKU to which information about the coffee beans 408 stored therein and/or brewing recipe(s) for the coffee beans 408 stored therein is linked. The brewing recipe(s) may be specific to achieving an optimal extraction of coffee from the coffee beans 408 for the particular SKU. Each pod/tag may only be used once, and the brewer itself or via connection to an external network may recognize whether the same pod/tag has been used before upon reading the identification tag 210.

### Capsule Dock and Linear Positioning Stage

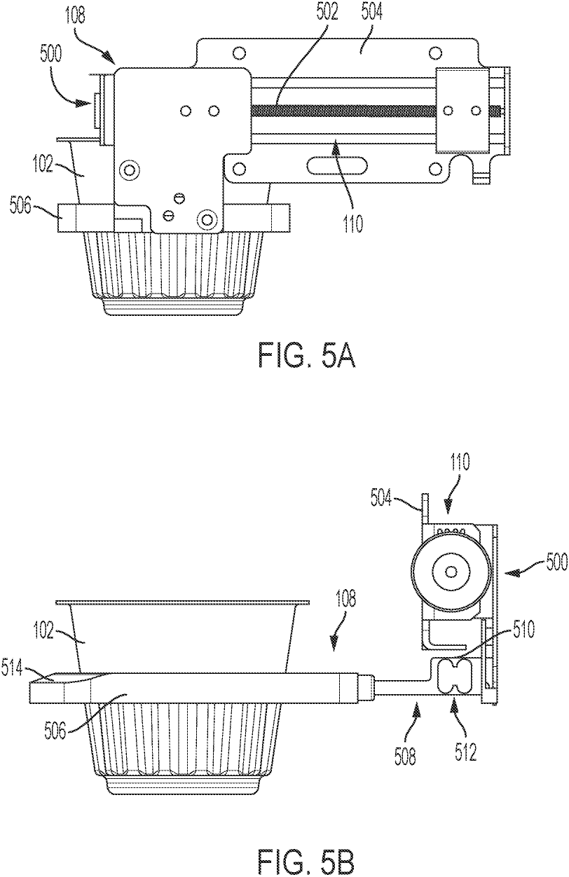

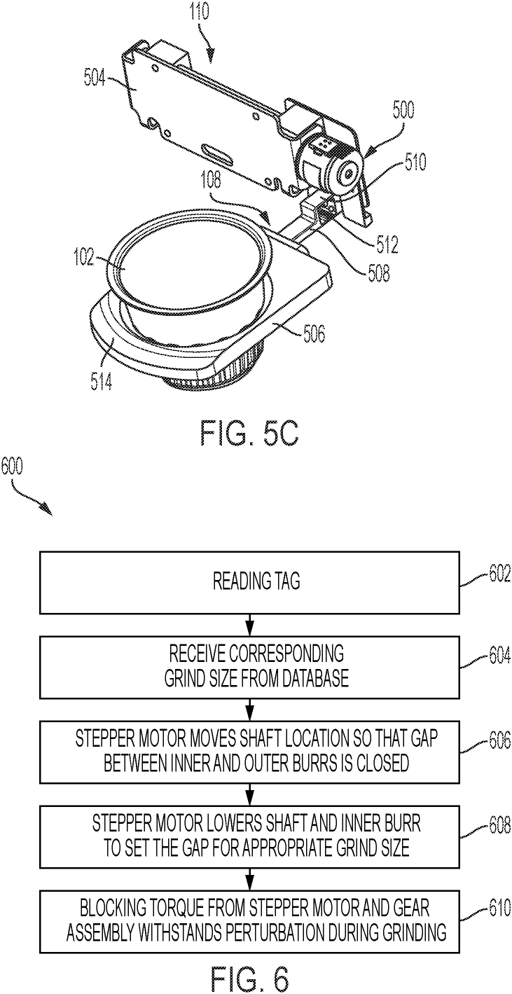

FIGS. 5A-5C depict an example capsule dock 108 and linear positioning stage 110 that may be used in the brewer. The capsule dock 108 and linear positioning stage 110 are specially designed to serve the following purposes: 1) holding the pod 102 in place during brewing; 2) confirming the pod 102 is in the correct position; 3) moving the pod 102 between the grinder and the water dispenser; 4) agitating the coffee/water mixture in the pod 102 during extraction; 5) measuring the weight of the coffee and water inside the pod 102; and 6) acting as an input button or switch with haptic feedback.

The capsule dock 108 combined with the linear positioning stage 110 form an assembly to bridge the grinder and the water dispenser of the brewer, first moving the pod 102 to a first location to receive coffee grounds, and then moving the pod 102 to a second location for water dispensing.

The linear positioning stage 110 provides linear translation of the capsule dock 108. The linear positioning stage 110 may include a stepper motor 500 that rotates a threaded guide 502 to provide the linear translation. This provides precise control of the position of the capsule dock 108. The linear positioning stage 110 may also include a mount 504 for mounting the linear positioning stage 110 inside the housing of the brewer. As shown in FIGS. 1, the capsule dock 108 may extend to an outside of the housing 118 of the brewer 100. The linear positioning stage 110 may include an integrated sensor (e.g., position or force sensor) configured to detect the location of the capsule dock 108 with respect to the housing of the brewer. Data collected from this sensor may be used to confirm that the pod 102 is in the correct position for the grinding or brewing operations being performed by the brewer.

In some embodiments, the motor 500 of the linear positioning stage 110 may be controlled to “shake” the capsule dock 108, thereby agitating the contents of the pod 102 held by the capsule dock 108. This vibration may shake the coffee grounds and water to more evenly distribute the mixture of coffee and water in the pod 102 during the brewing process. This may improve the consistency of the extraction, as desired for brewing certain types of coffee. In addition, the motor 500 may be controlled to provide agitation at a specific vibrational frequency, for a specific amount of time, and/or only during or after particular pours during the brewing process. Providing agitation control through the linear positioning stage 110 allows the brewer to execute specifically tailored brewing methods.

The capsule dock 108 may include a capsule holder 506 configured to receive the pod 102 therein. As illustrated, the capsule holder 506 may include a circular opening formed therein for gripping an outer surface of a frustoconical shaped pod 102. In other embodiments, the capsule holder 506 may take other forms. The capsule dock 108 may also include a connecting member 508 connecting the capsule holder 506 to the linear positioning stage 110. The linear positioning stage 110 may be controlled to move the connecting member 508 and capsule holder 506 with respect to the housing of the brewer. The connecting member 508, as shown, may be cantilevered from the linear positioning stage 110.

The capsule dock 108 may further include an integrated force sensor 510. The integrated force sensor 510 may be a strain gauge attached to a compliant structure 512 of the capsule dock 108. For example, as shown in FIGS. 5B and 5C, the integrated force sensor 510 may be a strain gauge attached to a compliant structure 512 of the connecting member 508. When a force (e.g., the weight of the pod 102 or a user’s click force) is applied to the capsule holder 506, the compliant structure 512 will deform slightly by the weight, and the strain gauge (e.g., 510) will measure the degree of deformation and calculate the applied force.

The integrated force sensor 510 may enable precision brewing. Based on information received from the force sensor 510, a controller of the brewer may know the exact amount of coffee grounds deposited into the pod 102 and the exact amount of water in the pod 102 throughout the extraction process. This information allows the system to realize unprecedented precision brewing as the amount of water and coffee grounds is measured precisely in real time.

Besides monitoring the water-to-coffee ratio, the force sensor 510 may also help the system detect any potential faults during use of the brewer. For example, the force sensor 510 may help the brewer detect an incorrect amount of coffee deposition (e.g., excessive beans output from the grinder, excessive grounds retention in the pod, etc.). Upon detecting an incorrect amount of coffee deposition, the controller of the brewer may output a notification (e.g., alert) to a user to check the amount of coffee deposition. In addition, the force sensor 510 may help the system detect a clogging of the pod 102, which may result in a restrained outflow of coffee. Upon detecting a clogged pod 102, the brewer may automatically stop dispensing water into the pod 102. In addition, the brewer may output a notification (e.g., alert) to a user to check on the condition of the pod 102.

The integrated force sensor 510 may enable the capsule dock to act as a button or switch by detecting a force applied directly by a user pressing on a front 514 of the capsule holder 506, thereby allowing the user to interact with the brewer. In an example, the linear positioning stage 110 driven by the stepper motor 500 may provide haptic feedback when the system registers a “click” action from the user pressing the capsule holder 506. One application of this user activated switch may be to activate the brewing process once the pod 102 is correctly installed in the capsule dock 108.

### Grinder System

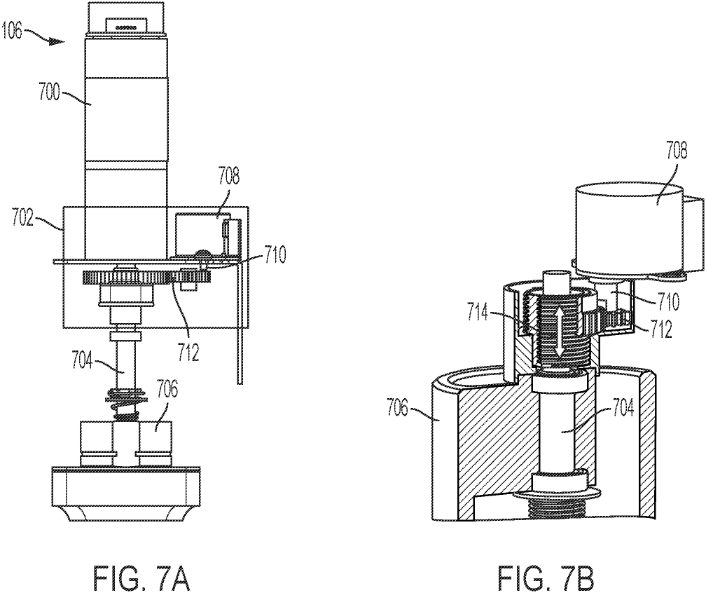

Turning now to FIGS. 6-7B, a method and assembly for grinding coffee beans or other materials input to the brewer will now be described.

When brewing a cup of coffee, grinding the coffee beans is an important step, as grind size alone can dramatically change the taste of the resulting cup of coffee. In addition, grinding the coffee beans immediately before brewing ensures maximum freshness and flavor of the coffee. Coffee can start to lose its flavor in as little as fifteen minutes after grinding.

When it comes to choosing the grind size for coffee beans, three factors of the selected brewing process make the largest difference: contact time, extraction rate, and flow rate of water through the coffee. Grinding the coffee finer increases the surface area of coffee grounds, increasing the extraction rate and reducing the flow rate of water (thereby increasing contact time). The higher the extraction rate, the less contact time is needed. Knowing this, if you have a brew method with a short contact time, the grind size should be finer. If the contact time is too high or the grind is too fine, the result may be an over-extracted brew that can be bitter. If the grind is too course or the contact time is too short, however, the coffee may turn out weak.

The disclosed brewer may recognize the type of coffee beans, how the beans were roasted, and the recommended brewing methods based on the information obtained based on the identification tag on the pod. With this information, the grinder may adjust the grind size and grind the coffee beans immediately before brewing to ensure maximum freshness and flavor.

FIG. 6 illustrates a method 600 for grinding whole coffee beans (or other materials) using a brewer, with FIGS. 7A and 7B depicting a grinder 106 that performs one or more steps of the method 600. At step 602, the method 600 may include reading the identification tag of the pod from which coffee beans are being supplied to the grinder 106. An electronic reader of the brewer may read the identification tag. At step 604, the method 600 may include receiving a corresponding grind size from a database via a controller of the brewer, as described above with reference to FIG. 2.

The grinder 106 may automatically adjust the grind size (e.g., coarseness level) of the coffee beans based on the recipe detected from the identification tag on the pod and/or based on user preferences (which may be learned by the brewer over time). The grinder 106 may automatically recalibrate and set to zero after each brewing operation or certain cycles of operations to guarantee the accuracy of grind size. As shown in FIGS. 7A and 7B, the grinder 106 may include a main motor 700, a main gearbox 702, a main shaft 704, a burr assembly 706 having an inner burr and an outer burr located in a housing, and a stepper motor 708 for grind size adjustment. As shown, the stepper motor 708 may be disposed in the main gearbox 702.

The stepper motor 708 is driving a mechanism that transfers a rotational movement of a secondary shaft 710 through one or more gears 712 to a linear movement 714 of the main shaft 704. The inner burr moves up and down together with the main shaft, while the outer burr is stationary and fixed with the main structure of the burr assembly 706. When a finer grind size is selected, the inner burr moves upward, reducing the gap between the inner and outer burrs. When a courser grind size is selected, the inner burr moves downward, increasing the gap between the inner and outer burrs.

At step 606, after retrieving the grind size from a database and/or user’s setting, the method 600 includes the stepper motor 708 axially moving the main shaft 704 so that a gap between the inner and outer burrs of the burr assembly 706 is closed. That way, the grinder 106 may self-calibrate to a “zero” position setting to ensure the accuracy and consistency of grind size. The main shaft 704 and inner burr may move upward until a gap between the inner burr and outer burr is closed (zero) and set this position as the “zero” position.

At step 608, the method 600 then includes the stepper motor 708 lowering the main shaft 704 and the inner burr attached thereto to set the gap for the appropriate grind size from step 604. The method 600 then proceeds to grinding the coffee beans in the burr assembly 706 of the grinder 106. This involves the main motor 700 rotating the main shaft 704 and the attached inner burr to grind the coffee beans between the inner and outer burrs in the burr assembly 706. At step 610, a blocking torque from the stepper motor 708 and gear assembly in the main gearbox 702 withstands perturbations during grinding. The system may constantly measure an output torque of the main motor 700 (e.g., via a sensor) to detect if the gap between the outer and inner burrs is in the correct position.

### Solid State Pouring System

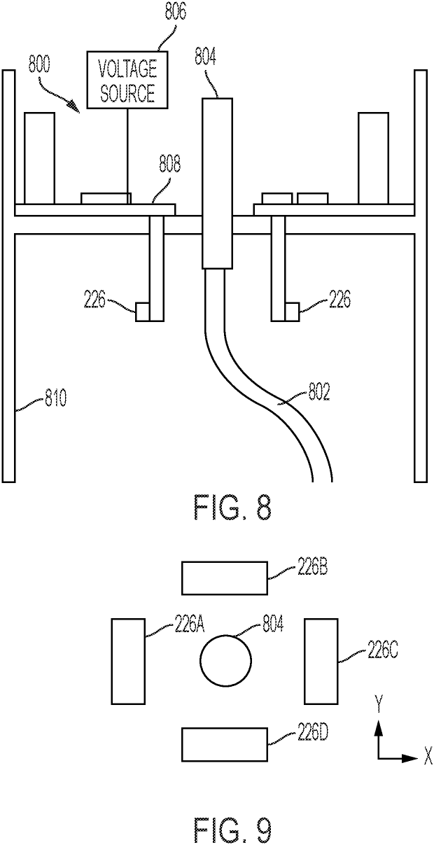

Turning now to FIGS. 8 and 9, a solid state pouring system for use in the water dispenser portion of the brewer will be described.

An optimal method to prepare a black coffee is the method of pour-over, as it accentuates intricate flavors when compared to other brewing methods. This makes it a popular choice for single-origin coffees since it allows the flavors and aromas to shine. For the pour-over method, the choreography of the pours (or “pouring pattern”) directly affects the end result of the cup of coffee. As such, the disclosed brewer provides complete control over how each pour is performed. The brewer may reproduce the precision, delicacy, and nuance of each pouring pattern. To achieve such results, the brewer may include a solid state pouring assembly capable of controlling the course of free water streams being dispensed without using any moving parts.

Water (H₂O) is a polar covalent molecule, which means that the molecules are attracted to nearby net electrical charges, regardless of the sign of the charges. The attraction force sometimes can be large enough to pull a stream of water towards the charge carriers. Therefore, one can change the direction of the water flow by controlling the distribution of the electric charges in the near vicinity of the water.

FIG. 8 illustrates an example solid state pouring system 800 that may be used to control a water stream 802 output from the brewer. The solid state pouring system 800 includes a water dispenser nozzle 804 configured to dispense the water stream 802, one or more electrodes 226 disposed adjacent to the water stream 802 dispensed by the nozzle 804, and at least one voltage source 806 electrically coupled to the one or more electrodes 226 through an electrical circuit (e.g., on a printed circuit board (PCB) 808). The nozzle 804 may be configured to dispense the water stream 802 in a laminar flow regime, which allows for more precise control of the water stream 802. To apply a desired amount of force to the water stream 802, the electrode(s) 226 are placed near the stream to create and control an electric charge distribution to bend the water stream 802 according to a pouring pattern. The electrode(s) 226 may each include an electrical conductor encased in an electrical isolation material. The electrode(s) 226 may also include a hydrophobic coating that insulates the conductive material from the environment and prevents liquid droplets from sticking to the surface of the electrode(s) 226.

The voltage source(s) 806 may include a high voltage generator or an electric charge generator. The voltage source(s) 806 may be used to control the charge density on each electrode 226. The force applied by the electrode 226 on the water stream 802 may increase (or decrease) with increasing (or decreasing) charge density. Each electrode 226 can be controlled separately by either an analog input signal or a pulse width modulated (PWM) digital signal. The electrodes’ activation patterns (e.g., duration, frequency, sequences, amplitude, etc.) can be set to realize the choreography of any desired pour-over patterns. The solid state pouring system 800 may include a housing 810 that isolates the high-voltage circuits from the rest of the system as well as provides structural support to the system.

Since the disclosed solid state pouring system 800 uses electrical charge on the electrode(s) 226 to bend the water stream 802, the system is able to mechanically manipulate the water stream 802 without using any moving parts of the brewer. The solid state pouring system 800 may enable the brewer to output each pour from the water dispenser according to a desired pouring pattern. The water dispenser of the brewer may control the pouring pattern, among other parameters (e.g., water volume, number of pours, water temperature, etc.), such that the water and coffee are well-mixed.

FIG. 9 represents an example 2-dimensional arrangement of electrodes 226 around a nozzle 804 and/or water stream dispensed from the nozzle 804, as viewed in a plane perpendicular to a longitudinal axis of the nozzle 804. The solid state pouring system may include four electrodes 226 arranged about the water stream. The electrodes 226 may each be equidistantly spaced from the water stream, with two electrodes (226A and 226C) on opposite sides of the nozzle 804 from each other in a direction parallel to an X-axis, and the other two electrodes (226B and 226D) on opposite sides of the nozzle 804 in a direction parallel to a Y-axis. Such a placement of electrodes 226 with respect to the nozzle 804 allows the brewer to control the water stream by controlling a force vector in orthogonal directions. That is, the system may control the charge applied to each of the four electrodes 226 via vector control (e.g., in the X-axis and Y-axis directions) to control the direction the water stream is bent during each pour. This arrangement of electrodes 226 enables the solid state pouring system to control the 360-degree radial orientation of the water stream around the axis of the nozzle 804. The solid state pouring system may also control the amplitude of the water stream away from a center (e.g., longitudinal axis of the nozzle 804). The solid state pouring system may provide time series control of the electrodes 226 to control the shape of a pour with respect to time. The solid state pouring system may provide any desired pouring pattern such as, for example, a spiral pouring pattern (e.g., growing from the center toward the outside, or vice versa) for each pour and output at any desired speed.

### Single-Serving Pod Embodiments

Additional details regarding single-serving pods compatible with the disclosed brewer will now be provided. Turning back to FIG. 4, the illustrated single-serving pod 102 includes a plurality of whole coffee beans 408 located within a capsule 400. The plurality of whole coffee beans 408 may include a number of whole coffee beans sufficient for brewing a single cup of coffee. The capsule 400 is configured to hold the whole coffee beans 408 therein and to later receive coffee grounds made from the whole coffee beans 408.

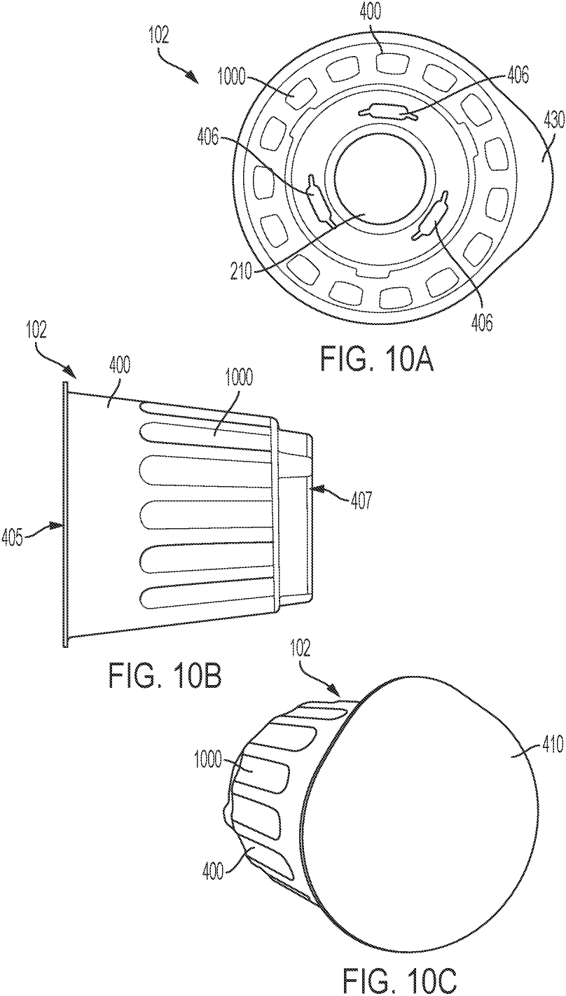

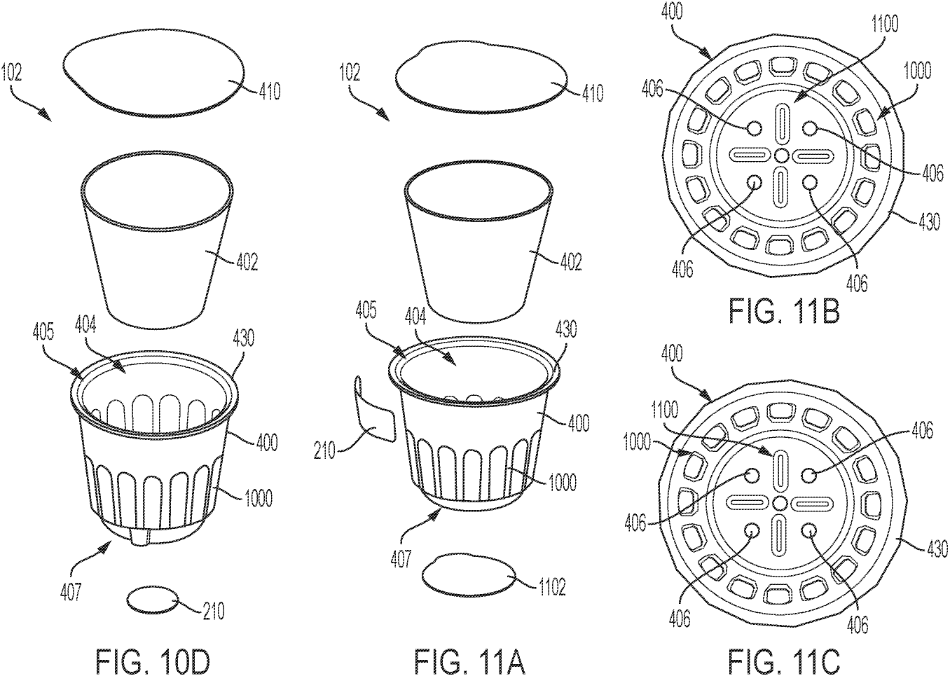

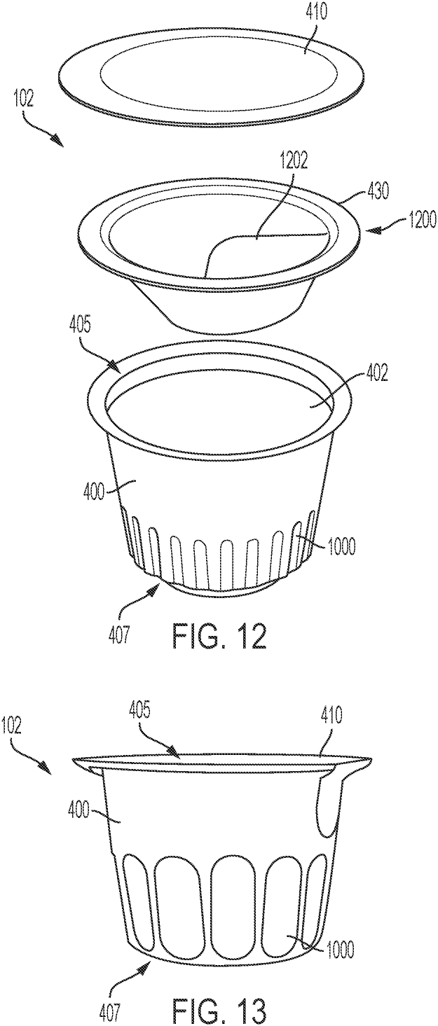

FIGS. 10A-10D are additional views of the single-serving pod 102 of FIG. 4. FIG. 11A illustrates another example single-serving pod 102, and FIGS. 11B and 11C depict the corresponding capsule 400 of that pod 102. FIG. 12 illustrates another example single-serving pod 102, and FIG. 13 illustrates yet another example single-serving pod 102. Similar elements on each pod 102 of FIGS. 10A-13 are labeled with similar element numbers as in FIG. 4.

In general, the hollow capsule 400 holding the brewing agent is frustoconical in shape. The capsule 400 may include extraction features for providing more effective extraction of flavor during the brewing process. For example, the capsule 400 may feature a combination of specially designed ribs, grooves, indentations, protrusions, and dripping holes to optimize extraction efficiency and outcomes. This design may reduce clogging caused by coffee grounds and the filter 402, which may otherwise lead to overextraction and bitterness of the coffee.

As an example, in FIGS. 10A-13 the capsules 400 each include a pattern of indentations and/or protrusions 1000 formed along a side wall of the capsule 400. Indentations and/or protrusions 1000 along the side wall of the capsule 400 may introduce air flow between edge of the capsule 400 and the filter 402, thereby helping with coffee extraction. Indentations and/or protrusions 1000 along the side wall of the capsule 400 may also increase the structural stability of the single-serving pod 102, so that the pod 102 does not become deformed during transport. The indentations and/or protrusions 1000 may be different sizes or shapes in different embodiments, as illustrated between FIGS. 10A-13. The indentations and/or protrusions 1000 may extend in a vertical direction along the side wall of the capsule 400 and may extend only part of the way from the bottom end 407 of the capsule 400 toward the upper end 405 of the capsule 400.

As another example, in FIGS. 11B and 11C, the capsule 400 includes a pattern of indentations and/or protrusions 1100 formed on the second end 407 of the capsule 400. Such indentations and/or protrusions 1100 may add some distance between a bottom of the filter (not shown) and the bottom of the capsule 400 to provide increased water flow and therefore better extraction. In addition, the indentations and/or protrusions 1100 may increase the structural stability of the single-serving pod 102, so that the pod 102 does not become deformed during transport. The openings 406 in the bottom of the capsule 400 may be arranged in a specific pattern around the indentations and/or protrusions 1100 to help with extraction and smooth the dripping.

As shown in FIGS. 4, 10A, 10D, and 11A, the single-serving pod 102 may include an identification tag 210 disposed on the capsule 400. The identification tag 210 is configured to be scanned by a reader (e.g., of the brewer). The identification tag 210 is configured to provide or trigger access to information upon scanning of the identification tag by the reader. This information may correspond to the whole coffee beans held in the capsule 400, to a recipe for brewing coffee from whole coffee beans in the capsule 400, or both. In this way, the identification tag 210 may represent or contain information stored thereon about the whole coffee beans and/or a method for brewing coffee from the beans. The information corresponding to the coffee beans may include, for example, a bean name, a bean type, a bean growing region, a grower, a roaster, a processing method, a roasting date, a packing factory, a packaging date, or a best by date. The information corresponding to the recipe for brewing coffee from the beans may include, for example, a grind size, a water temperature, a water volume, a pouring pattern, a number of pours, or an agitation instruction. The identification tag 210 may comprise a radio frequency identification tag (RFID tag). As discussed at length above, the identification tag 210 may have an SKU stored therein, which can be used by the brewer to access additional information corresponding to the coffee beans and/or the brewing recipe from an external network.

As illustrated in FIGS. 4, 10A, and 10D, the identification tag 210 may be disposed on the second end 407 of the capsule 400. As shown in FIG. 10A, the drip openings 406 in the second end 407 of the capsule 400 may be specially shaped and/or arranged around a perimeter of the identification tag 210. In another example, as shown in FIG. 11A, the identification tag may be disposed along a side wall of the capsule 400.

As shown in FIGS. 4, 10C, 10D, 11A, 12, and 13, the capsule 400 may be sealed at an the upper end 405 by the removable covering 410. This removable covering 410 may be sealed to a flange 430 surrounding the opening 404 at the upper end 405 via application of heat, so that no adhesive material is left on the capsule 400 upon removal of the covering 410. In other embodiments, the covering 410 may be applied via adhesive, or may include a removable lid. The removable covering 410 may serve as a label for the single-serving pod 102, as shown in FIGS. 10C and 10D.

In some embodiments, the bottom end 407 of the capsule 400 may be sealed as well. For example, as shown in FIG. 11A, the single-serving pod 102 may include a second removable covering 1102 disposed over the at least one smaller opening in the second end 407 of the capsule 400. The second removable covering 1102 may help to fully seal the capsule 400 by covering the holes on the bottom end of the capsule 400. This fully seals the beans against air inside the capsule 400, maintaining their freshness. This second removable covering 1102 would need to be removed along with the upper removable covering 410 before the pod 102 can be used as a dripper.

In other embodiments, the bottom end 407 of the capsule 400 may be left unsealed, without a covering over the drip holes. To seal in freshness of the coffee beans therein, the single-serving pod 102 may be packaged in a sealed bag together with multiple other single-serving pods for storage and shipping to a user. This arrangement means that a user would only have to remove a single covering 410 when it is time to brew the coffee.

Each pod 102 of FIGS. 4 and 10A-13 includes a filter 402 (e.g., coffee filter). In an example, the capsule 400 and/or the filter 402 may be made from 100% eco-friendly materials that are renewable, biodegradable, and/or compostable. As an example, the capsule 400 and/or the filter 402 may be made from a 100% biodegradable material, such as sugar cane fiber or another plant-based fiber. As such, the single-serving pod 102 may pose a much smaller environmental impact compared to plastic or metallic coffee capsules.

As illustrated in FIG. 4, the plurality of whole coffee beans 408 may be located inside the coffee filter 402. Similarly, in the embodiment of FIG. 11A, the filter 402 is configured to hold whole coffee beans therein as well.

In the embodiment of FIG. 12, the single-serving pod 102 includes a removable container 1200 disposed within the capsule 400 and covered by the removable covering 410. The plurality of whole coffee beans for the pod 102 may be located in this removable container 1200, instead of loose in the filter 402 below. The removable container 1200 acts as a separate compartment to store and seal the beans from moisture and oxygen. This may enable the pod 102 to fully seal the coffee beans from air without requiring an additional removable covering at a bottom end of the capsule 400. The removable container 1200 may include a septum 1202 configured to enable a user to easily grasp the removable container 1200 with their fingers to lift the removable container 1200 out of the capsule 400 and pour the beans into the brewer.

Numerous modifications, alterations, and changes to the described embodiments are possible without departing from the scope of the present invention defined in the claims. It is intended that the present invention not be limited to the described embodiments, but that it has the full scope defined by the language of the following claims, and equivalents thereof.

What is claimed is:

1. A single-serving coffee pod, comprising:
a hollow capsule having an opening at a first end thereof and at least one smaller opening in a second end thereof opposite the first end;
a filter disposed within the capsule;
a plurality of whole coffee beans located within the capsule; and
a removable covering disposed over the opening of the capsule.

2. The single-serving coffee pod of claim 1, wherein the plurality of whole coffee beans comprise a number of whole coffee beans sufficient for brewing a single cup of coffee.

3. The single-serving coffee pod of claim 1, further comprising a second removable covering disposed over the at least one smaller opening in the second end of the capsule.

4. The single-serving coffee pod of claim 1, wherein the plurality of whole coffee beans are located inside the coffee filter.

5. The single-serving coffee pod of claim 1, wherein the capsule, the coffee filter, or both is made from a biodegradable material.

6. The single-serving coffee pod of claim 1, further comprising a removable container disposed within the capsule and covered by the removable covering, wherein the plurality of whole coffee beans are located in the removable container.

7. The single-serving coffee pod of claim 6, wherein the removable container comprises a septum configured to enable a user to lift the removable container out of the capsule.

8. The single-serving coffee pod of claim 1, further comprising an identification tag representing or containing information stored thereon about the whole coffee beans and/or about a method for brewing coffee from the whole coffee beans.

9. The single-serving coffee pod of claim 8, wherein the identification tag is disposed along a side wall of the capsule or on the second end of the capsule.

10. The single-serving coffee pod of claim 1, wherein the capsule comprises a pattern of indentations and/or protrusions along a side wall of the capsule.

11. The single-serving coffee pod of claim 1, wherein the capsule comprises a pattern of indentations and/or protrusions on the second end of the capsule.

12. The single-serving coffee pod of claim 1, wherein the capsule is frustoconical in shape.

13. A single-serving coffee pod, comprising:
a hollow capsule configured to hold whole coffee beans therein and to receive coffee grounds made from the whole coffee beans; and
an identification tag disposed on the capsule, the identification tag configured to be scanned by a reader, wherein the identification tag is configured to provide or trigger access to information upon scanning of the identification tag by the reader, the information corresponding to the whole coffee beans held in the capsule, corresponding to a recipe for brewing coffee from the whole coffee beans in the capsule, or both.

14. The single-serving coffee pod of claim 13, wherein the information corresponding to the coffee beans comprises a bean name, a bean type, a bean growing region, a grower, a roaster, a packaging date, or a best by date.

15. The single-serving coffee pod of claim 13, wherein the information corresponding to the recipe for brewing coffee from the coffee beans comprises a grind size, a water temperature, a water volume, a pouring pattern, a number of pours, or an agitation instruction.

16. The single-serving coffee pod of claim 13, wherein the identification tag is a radio frequency identification tag (RFID tag).

17. The single-serving coffee pod of claim 13, further comprising:
a filter disposed inside the capsule;
an opening disposed at a first end of the capsule; and
a smaller opening disposed at a second end of the capsule opposite the first end.

18. The single-serving coffee pod of claim 17, wherein the identification tag is disposed on the second end of the capsule.

19. The single-serving coffee pod of claim 13, wherein the identification tag is disposed along a side wall of the capsule.

20. A single-serving beverage brewing system comprising:
a brewer comprising a reader; and
a single-serving pod comprising:
a hollow capsule configured to hold a brewing agent therein; and
an identification tag disposed on the capsule,
wherein the brewer further comprises a processor communicatively coupled to the reader, wherein in response to the reader reading the identification tag, the processor is configured to access or retrieve information regarding: the brewing agent, a recipe for brewing a beverage from the brewing agent, or both.
